(19) United States
(12) Patent Application Publication
(10) Pub. No.: US 2014/0195262 A1
(43) Pub. Date: Jul. 10, 2014

(54) DRUG REGISTRATION APPARATUS AND PROGRAM

(71) Applicant: TOSHIBA TEC KABUSHIKI KAISHA, Tokyo (JP)

(72) Inventors: Yumiko OKUMA, Tokyo (JP); Maki SATO, Kanagawa (JP); Shiomi MATSUI, Shizuoka (JP)

(73) Assignee: TOSHIBA TEC KABUSHIKI KAISHA, Tokyo (JP)

(21) Appl. No.: 14/148,368

(22) Filed: Jan. 6, 2014

(30) Foreign Application Priority Data
Jan. 10, 2013 (JP) 2013-002963

(51) Int. Cl. G06F 19/00

(52) U.S. Cl. CPC G06F 19/3456
USPC 705/2

(57) ABSTRACT

A drug registration apparatus includes a registration module configured to store a name of drug. The drug may have been administered to a patient during a medical procedure, such as an operation or surgery. A display control module is configured to display, on a display unit, the drug name stored by the registration module, drug information (e.g., dose level) associated with the drug name, and other information related to the context of the usage of the drug corresponding to the name. For example, a list of drug names and drug information corresponding to drugs administered to a patient during a surgical operation can be established and displayed on a display unit along with additional information related to patient identity and/or the medical procedure performed.

### CROSS-REFERENCE TO RELATED APPLICATION

This application is based upon and claims the benefit of priority from Japanese Patent Application No. 2013-002963, filed Jan. 10, 2013, the entire contents of which are incorporated herein by reference.

### FIELD

Embodiments described herein relate generally to a drug registration apparatus and a control program used therein.

### BACKGROUND

In order to minimize occurrence of dispensing errors, some systems for supporting dispensing works (pharmacy operations) have been proposed. For example, in one known system, quantities of prescribed drugs are stored in a data storage unit and are displayed on a display such that each time bar codes on containers of various drugs are read during the filling of a prescription for a patient, the quantity, name, and other information concerning the drug can be pulled from a data storage unit (e.g., a database) and can be checked against the drug prescription or administration instructions to help prevent wrong drugs, improper dosages, and expired drugs from being administered to a patient.

In an operating room or similar environment, typically a nurse will be required to collect empty containers of drugs used during the operation, and then manually write down on a slip of paper the list of drugs used during the operation corresponding to the collected empty containers. After the manual inventory slip is prepared, it must be submitted to, for example, a medical affairs department for medical records storage and/or other processing (e.g., updating pharmacy inventory records). Collection and recording of information using these procedures may be prone to errors, especially in an operating room or similar environment.

### DESCRIPTION OF THE DRAWINGS

FIG. 1 is a block diagram depicting a drug management system according to an embodiment.

FIG. 2 depicts an external appearance of a drug registration apparatus according to an embodiment.

FIG. 3 is a block diagram depicting hardware components of the drug registration apparatus according to an embodiment.

FIG. 4 is a block diagram depicting functional components of the drug registration apparatus according to an embodiment.

FIG. 5 is a flowchart depicting a drug registration process in the drug registration apparatus according to an embodiment.

FIG. 6 depicts an example of a login screen.

FIG. 7 depicts an example of a patient registration screen.

FIG. 8 depicts an example of a drug registration screen.

FIG. 9 depicts an example of a drug registration screen.

### DETAILED DESCRIPTION

The recording and collection of information concerning drugs used or expended during surgery or other procedures in an operating room environment, which may often occur in an atmosphere of emergency or extreme urgency, is typically left to a nurse, a pharmacist, or medical assistant. Collection and recording of information by humans is prone to error even when not occurring during (or soon after) tense emergency situations.

In an embodiment, a drug registration apparatus includes a registration module configured to store a name of drug. The name may be stored in a storage unit. The registered drug name correspond to a drug that may have been administered (or is intended to be administered) to a patient during a medical procedure, such as an operation or surgery. A display control module is configured to display, on a display unit, the drug name stored by the registration module, drug information (e.g., dose level) associated with the drug name, and other information related to the context of the usage of the drug corresponding to the drug name. For example, a list of drug names and drug information corresponding to drugs administered to a patient during a surgical operation can be established and displayed on a display unit along with additional information related to patient identity and/or the medical procedure performed.

According to another embodiment, a drug registration apparatus includes a registration means configured to register an expended drug in a storage unit, and a display control means configured to display in a list the drug information of the drugs registered by the registration means, and to display contextual information (e.g., patient name, date of administration, medical procedure type, etc.) corresponding to the administration of the drug, on a display unit.

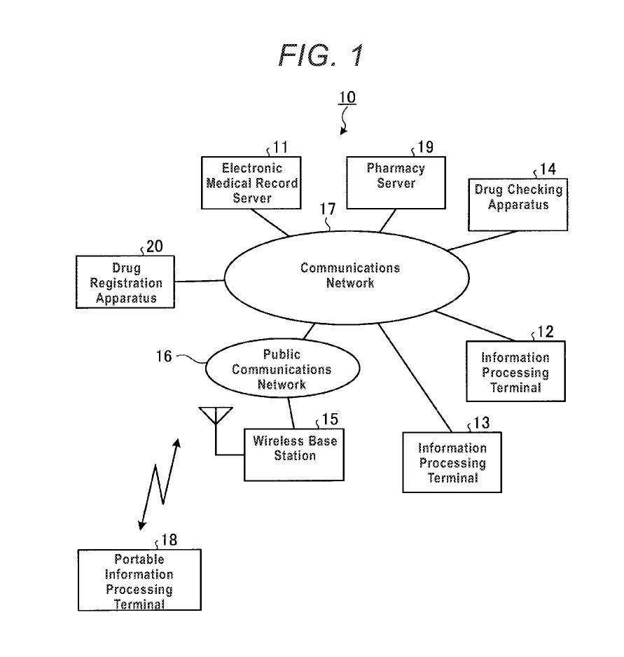

FIG. 1 is a block diagram depicting a drug management system according to an embodiment. As shown in FIG. 1, the drug management system 10 includes an electronic medical record server 11, an information processing terminal 12 for used by, for example, doctors, an information processing terminal 13 for use by, for example, nurses, a drug checking apparatus 14, a portable information processing terminal 18 for doctors connected to a communications network 17 via a wireless base station 15 and a public communications network 16, a pharmacy server 19, and a drug registration apparatus 20.

The electronic medical record server 11 is configured for managing and storing electronic medical records.

The information processing terminal 12 is a device for writing/editing electronic medical records.

The information processing terminal 13 is a device for referring to and checking electronic medical records managed by the electronic medical record server 11.

The drug checking apparatus 14 is an apparatus for supporting and cross-checking drug preparation (e.g., prescription filling) or the like, based on instruction information (e.g., prescription information) included in an electronic medical record.

The pharmacy server 19 is for managing the dispensing of drugs and the like. The pharmacy server 19 may be a device placed in a pharmacy. The pharmacy server 19 stores drug information (such as names, dosages, available quantities, etc.) related to each drug associated with code information placed on the drug or drug containers storing the drug. Information associated with drugs may include label images of the drug container, images of the drug (e.g., photos of pills, capsules, vials, ampoules, etc. corresponding to an administrable increment of the drug), and descriptions of the drug relating to physical appearance of the administrable increment of the drug (e.g., pills, capsules, lozenges, ampoules, vials, etc.) such as the size, shape, colors, and/or imprinted/molded/printed text (or images) on administrable increment of the drug.

The drug registration apparatus 20 is an apparatus that can be placed in an operating room to support registration of drugs used during an operation or emergency procedure. In an example embodiment, the drug registration apparatus 20 is located in a sterile operating room and can be used by a nurse to register the drugs used during a medical operation, such as surgery. In other embodiments, the drug registration apparatus may be located in, for example, an emergency room to register the drugs used during a non-surgical medical operation.

In the example embodiment, the electronic medical record server 11, the information processing terminal 12, the information processing terminal 13, the drug checking apparatus 14, the pharmacy server 19, and the drug registration apparatus 20 are connected to communications network 17.

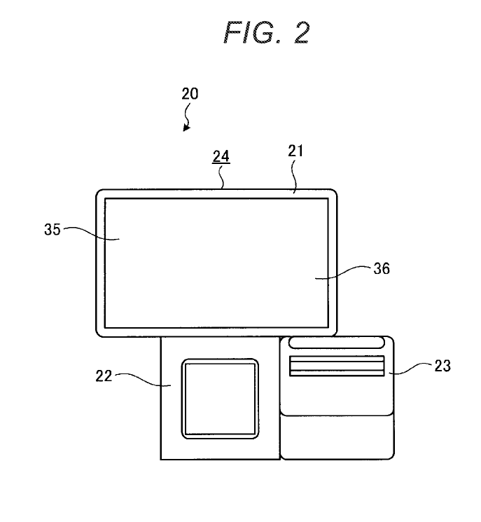

FIG. 2 depicts the external appearance of the drug registration apparatus 20 of an embodiment. As shown in FIG. 2, the drug registration apparatus 20 includes an apparatus main body 24 constituting a control main body of the drug registration apparatus 20, a scanner 22, and a printer 23 for printing out various information.

The apparatus main body 24 includes a touch panel display 21 through which a nurse or other operator performs various input operations and which is capable of displaying various information such as a list of drugs used in an operation.

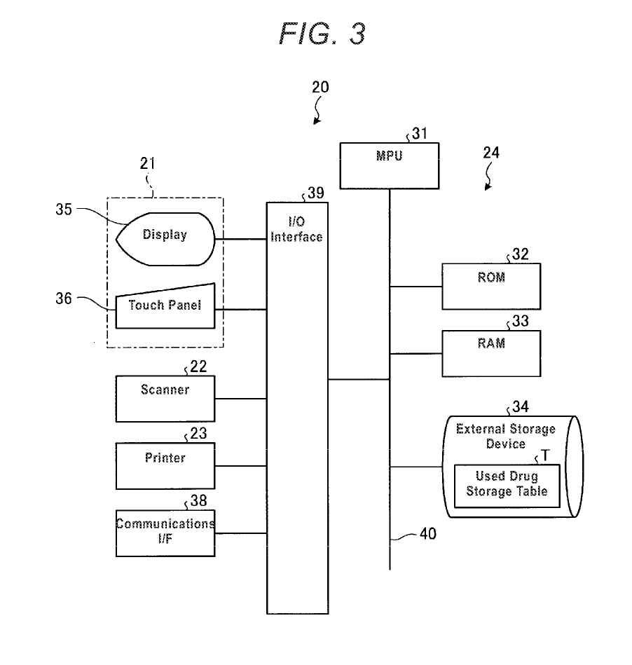

The scanner 22 includes an image sensor (not specifically depicted) such as a color CCD image sensor or a color CMOS image sensor, and a light source (not specifically depicted) such as an LED. The scanner 22 takes images of coded symbols on nurse IDs, patient IDs, and drug containers, and/or images of the drugs used in the operation. Frame images sequentially taken by the scanner 22 at a given frame rate can be stored in a random access memory (RAM) 33 (see FIG. 3).

The scanner 22 is not limited to the form of being placed on a table as depicted in FIG. 2, and may alternatively be in the form of a stand erected on the floor.

The drug registration apparatus 20 may additionally include a scale for measuring drug weight, an RFID reader/writer for reading and writing data from and to RFIDs attached to drugs, or the like.

FIG. 3 is a block diagram depicting a hardware configuration of the drug registration apparatus 20. As shown in FIG. 3, the drug registration apparatus 20 includes, within the apparatus main body 24, a micro processing unit (MPU) 31 for controlling the whole apparatus, a read only memory (ROM) 32, RAM 33, an external storage device 34, and a communications interface (I/F) 38 for performing communications interface operations.

The ROM 32 stores various data including control programs in a nonvolatile manner.

The RAM 33 functions as a work area and temporarily stores various data.

The external storage device 34 is composed of a hard disk drive or a solid state drive (SSD) capable of storing large-capacity data such as a data base and control programs.

In this embodiment, the touch panel display 21, the scanner 22, the printer 23, and the communications interface 38 are connected to a bus 40 via an input and output interface (I/O interface) 39. To the bus 40, the MPU 31, the ROM 32, the RAM 33, and the external storage device 34 are connected.

The touch panel display 21 comprises a display 35 as a display unit and a touch panel 36.

The external storage device 34 includes a used drug storage table T for storing collected results for drugs used in an operation.

With this configuration, the MPU 31 in the drug registration apparatus 20 operates according to the control programs stored in the ROM 32 and the external storage device 34, thereby supporting the registration of drugs used in an operation.

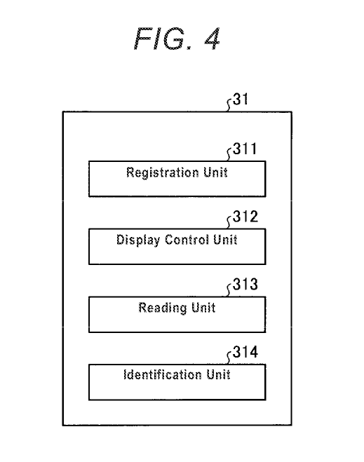

Next, characteristic functions of the drug registration apparatus 20 according to the embodiment will be described. FIG. 4 is a block diagram depicting the functional configuration of the drug registration apparatus 20.

The MPU 31 operates according to the control programs stored in the ROM 32 and the external storage device 34, thereby providing the functions of a registration unit 311, a display control unit 312, a reading unit 313, and an identification unit 314 as shown in FIG. 4.

The reading unit 313 reads, from an image scanned and taken by the scanner 22, code information from a code symbol attached to a drug used in an operation. The reading unit 313 may also read an image corresponding to the exterior appearance of all of or part of a specific drug used in an operation (such as features representing a label of the drug or features representing the surface state of the drug such as the color or projections and depressions (e.g., molded or imprinted text) on the drug's surface). Thus, the reading unit 313 may read an image, acquired using scanner 22, and the image may be of a pill, capsule, or other administrable increment of a drug, or the image may be of a drug container. The image may be used for determining the identity of the drug used in an operation without reference to code information (such as a bar code) printed on a container or label. The reading unit 313 may also be configured to read both code information and acquire other images of the drug for determining the identity of the drugs used in an operation.

A process of detecting and reading code information from a code symbol such as a bar code or a two-dimensional code is a conventional art, and will not be described here in detail.

The identification unit 314 identifies a drug based on information (e.g., code information or exterior information) obtained by the reading unit 313.

To identify a drug based on code information, drug information (such as names and amounts) associated with the code information is stored in advance in a table and can be extracted from the table based on the code information.

To identify a drug based on exterior information (such as features representing the label of the drug, or features representing the surface state of an administrable increment of the drug such as the color or projections and depressions on the surface of a pill, capsule, lozenge, syringe, etc.), exterior information corresponding to drugs which might be used during an operation is stored in advance in a table so that drug information corresponding to the exterior information can be extracted from the table.

The registration unit 311 registers a drug identified by the identification unit 314 in the used drug storage table T in the external storage device 34 functioning as a storage unit.

The display control unit 312 displays on the display 35 (display unit) a list of drug information associated with drugs registered by the registration unit 311, and also displays information relating to the situation in the operating room in which the drug was used—for example, a name of the patient present in the operating room. The display control unit 312 displays information relating to the situation in the operating room in watermark characters (e.g., this information is shown in a color lighter than the color of the displayed list of drugs registered by the registration unit 311).

Next, an expended drug registration process is performed by the MPU 31 in the drug registration apparatus 20 according in accordance with the control programs stored in non-transitory, computer-readable storage components.

The drug registration apparatus 20 according to an embodiment scans code symbols of drugs used in an operation or acquires images of the drugs used in the operation, and performs the expended drug registration process after the operation.

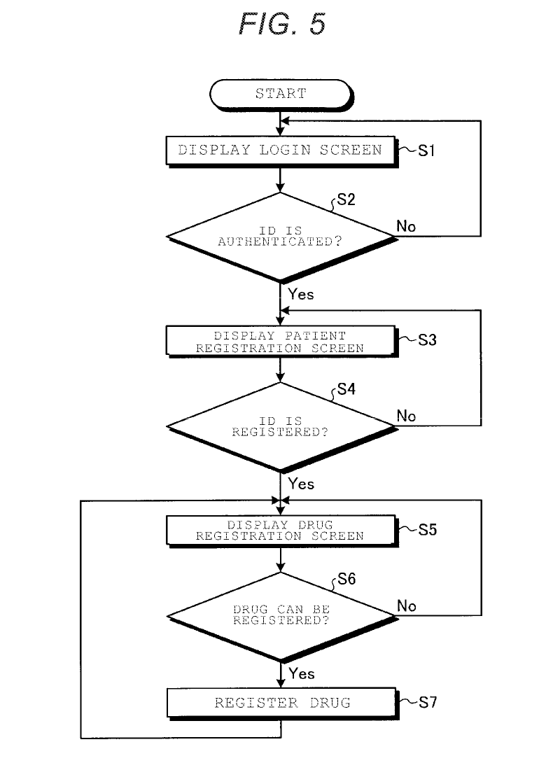

FIG. 5 is a flowchart depicting the expended drug registration process performed by the MPU 31 in the drug registration apparatus 20.

As indicated in FIG. 5, the MPU 31 displays, in an initial state, a login screen on the display 35 (step S1). An operator (e.g., a nurse) who is authorized to operate the drug registration apparatus 20 has an ID card, and is allowed to operate the drug registration apparatus 20 after authentication of the ID card.

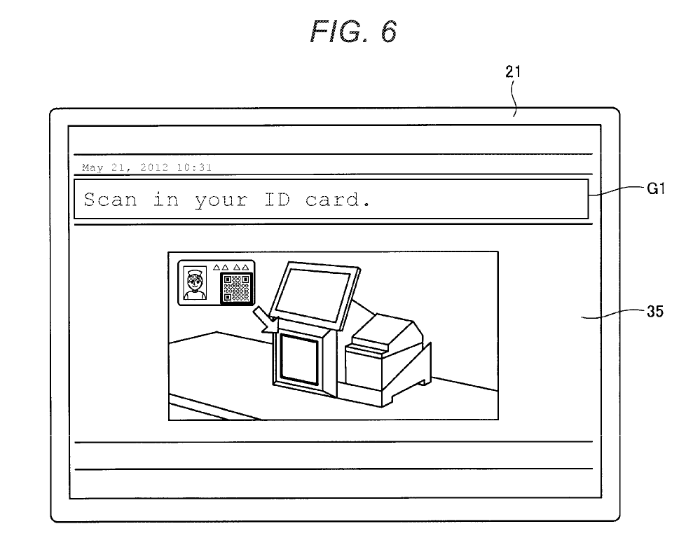

FIG. 6 depicts an example of a login screen G1. On the login screen G1, a guide comment (“Scan in your ID card.”) and a guide image prompting the operator to use scanner 22 to read an ID card are displayed. The ID card may have a code symbol corresponding to a particular operator's identity printed or formed thereon. Accordingly, to perform login processing, the operator (nurse) holds his or her ID card in front of the scanner 22 to have the operator ID read in.

After the MPU 31 in the drug registration apparatus 20 authenticates the operator ID by login processing (Yes in step S2), the MPU 31 displays a patient registration screen on display 35 (step S3). When the MPU 31 in the drug registration apparatus 20 cannot authenticate the nurse ID (No in step S2), the MPU 31 returns to step S1, and displays the login screen G1 again.

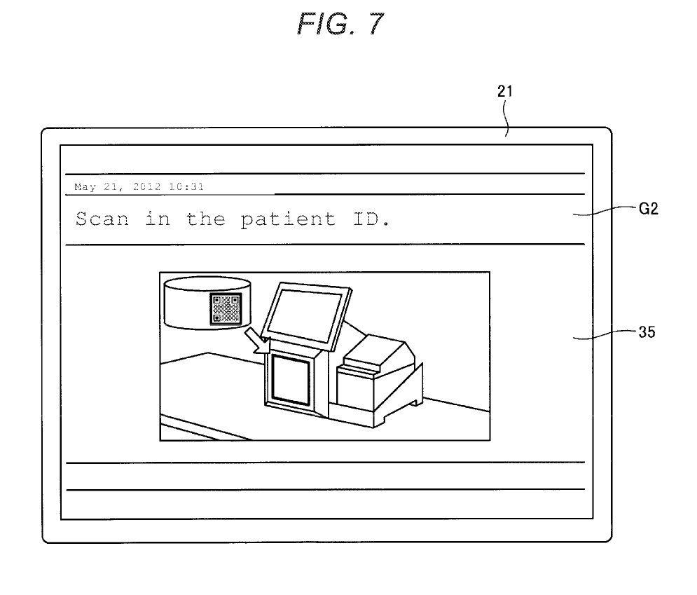

FIG. 7 depicts an example of a patient registration screen G2. On the patient registration screen G2, as shown in FIG. 7, a guide comment (“Scan in the patient ID.”) and a guide image prompting reading of the code symbol of a patient ID attached to a wristband of the patient are displayed. Scanner 22 may be used to read the patient ID. Accordingly, to perform patient registration processing, the operator (nurse) holds the code symbol of the patient ID attached to the wristband of the patient in front of the scanner 22 to have the patient ID read in.

After the MPU 31 registers the patient ID by the patient registration processing (Yes in step S4), the MPU 31 displays on the display 35 a drug registration screen G3 for registering a drug used (expended) during the operation (step S5). When the MPU 31 cannot register the patient ID (No in step S4), the MPU 31 returns to step S3 and displays the patient registration screen G2 again.

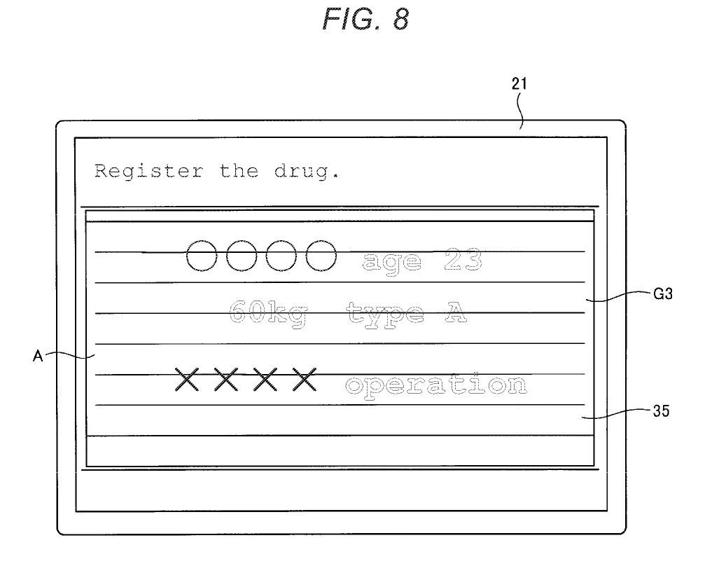

FIG. 8 depicts an example of the drug registration screen G3. On the drug registration screen G3, as shown in FIG. 8, in an initial state, a guide comment (“Register the drug.”) and a registration display A showing watermark characters in the background are displayed. The registration display A is an area on which a drug (or drugs) used in an operation is displayed. The watermark characters are displayed in a color lighter than the color of the display of a drug so as not to interfere with the display of the list of drugs used in an operation.

Information provided in watermark characters on the registration display A is, for example, contextual information related to the situation in an operating room (a procedure name, patient information (such as weight, a blood type, other details of note,) or other information of potential importance)). The contextual information associated with the patient ID, for example, is registered in the electronic medical record server 11. That is, contextual information displayed in watermark characters is a meaningful display related to drugs displayed on the registration display A.
Operation name (operative method): Drugs used are determined, and thus overlapping display thereof is meaningful.
Weight of the patient: The weight is related to the dose of a drug, and thus overlapping display thereof is meaningful.
Blood type: The blood type is related to a blood transfusion error, and thus overlapping display thereof is meaningful.
Details of note: Allergy information (such as on latex allergy), for example, is related to surgical instruments (latex gloves, catheters, and anesthetic instruments), and thus overlapping display thereof is meaningful.

With the drug registration screen G3 displayed on the display 35 like this, the operator (nurse) holds the code symbol of a drug used in the operation or the drug in front of the scanner 22 to have the image of the code symbol of the drug or an image of the drug itself read in.

When the MPU 31 can register the drug used in the operation based on the code information or the exterior information (such as features representing the label of the drug or features representing the surface state of the drug such as the color or projections and depressions on the surface) obtained from the image scanned and taken by the scanner 22 (Yes in step S6), the MPU 31 registers the drug used in the operation in association with the patient ID in the expended drug storage table Tin the external storage device 34 (step S7), and returns to step S5.

Whether the drug can be registered or not is determined, depending on whether drug information on the drug (such as names and amounts) associated with the code information on the drug or the exterior information obtained from the image scanned and taken by the scanner 22 is registered in the pharmacy server 19 or not.

When the MPU 31 returns to step S5, the MPU 31 displays the previously registered drug(s) on the registration display A in the drug registration screen G3 displayed on the display 35.

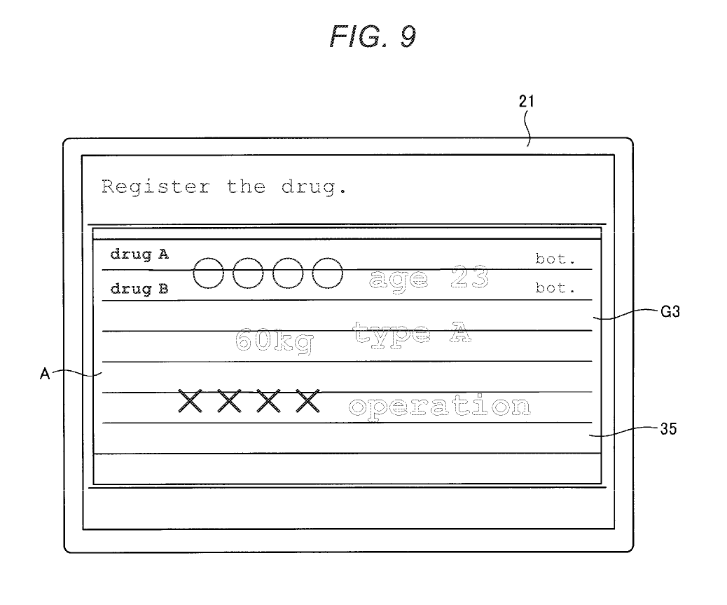

FIG. 9 depicts an example of the drug registration screen G3. On the drug registration screen G3 after the registration of drugs, as shown in FIG. 9, drug information (such as names and amounts) on registered drugs obtained from the pharmacy server 19 is displayed in a list in watermark characters on the registration display A.

Thus in the drug registration apparatus 20 in an embodiment, contextual information related to a situation in an operating room (for example, an operation name and patient information (such as weight, a blood type, and other details of note)) and drug information (such as names and amounts) on drugs used in an operation are displayed together, thereby allowing the following matters, for example, to be checked in an instant.
The relationship between drugs expended in an operation and drugs registered using the drug registration apparatus 20.
The suitability of drugs for a patient undergoing an operation.
The relationship between the weight of a patient undergoing an operation and the amounts (dosages) of drugs.

When the MPU 31 determines that the drug used in the operation cannot be registered based on the code of the drug or the image of the drug (No in step S6), the MPU 31 returns to step S5, and displays the drug registration screen G3 again without change.

The expended drug registration processing can be terminated by the operator (nurse) operating a termination button or the like.

Thus, with the drug registration apparatus 20, drugs used in an operation or drugs used in an emergency or the like can be managed reliably, and drug information (such as names and amounts) on drugs used in an operation or in an emergency or the like is displayed in a list in watermark characters showing contextual information concerning a situation in the operating room, thereby allowing for simultaneous checking of the contextual information against the information on the registered drugs, which can result in early detection of an administration error or a dosage error of a drug used or to be used in an operation or in an emergency.

In the example embodiment, registration of drugs already expended in an operation has been described, but this is not intended to be limiting. For example, it is possible to register in advance drugs that may be used in an operation before the drugs are actually used in the operation, so as to detect a drug administration error before administration. Similarly, while the administration of drugs to a patient has been described, usage (administration) of such things as blood, saline, or various intravenous solutions may be registered in some embodiments.

The control programs executed in the drug registration apparatus 20 of the embodiment are recorded and provided in an installable format or executable format file in a non-transitory, computer-readable medium such as a CD-ROM, a flexible disc (FD), a CD-R, or a digital versatile disk (DVD).

Alternatively, the control programs executed in the drug registration apparatus 20 of the embodiment may be configured to be stored on a computer connected to a network such as the Internet to be downloaded and provided via the network. Alternatively, the control programs executed in the drug registration apparatus 20 of the embodiment may be configured to be provided or distributed via a network such as the Internet or to operate across a network.

Alternatively, the control programs executed in the drug registration apparatus 20 of the embodiment may be configured to be incorporated in advance into a ROM or the like.

While certain embodiments have been described, these embodiments have been presented byway of example only, and are not intended to limit the scope of the inventions. Indeed, the novel embodiments described herein maybe embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A drug registration apparatus, comprising:
a registration module configured to store a drug name; and
a display control module configured to display, on a display unit, the drug name stored by the registration module, drug information associated with the drug name stored by the registration module, and contextual information related to a usage of a drug corresponding to the drug name stored by the registration module.

2. The apparatus according to claim 1, wherein the display control module is configured to display the contextual information in watermark characters in a color that is lighter than a color in which the drug name is displayed.

3. The apparatus according to claim 1, further comprising:
a scanner unit configured to read a code symbol on a drug container,
wherein the registration module is configured to use the code symbol that is read to determine the drug name.

4. The apparatus according to claim 1, further comprising:
a scanner unit configured to acquire an image of a drug container,
wherein the registration module is configured to use the image of the drug container that is acquired to determine the drug name.

5. The apparatus according to claim 1, further comprising:
a scanner unit configured to acquire an image of an administrable increment of a drug,
wherein the registration module is configured to use the image of the administrable increment of the drug that is acquired to determine the drug name.

6. The apparatus according to claim 5, wherein the scanner unit is configured to acquire a plurality of images of the administrable increment of the drug, and use the plurality of images that is acquired to determine the drug name.

7. The apparatus according to claim 5, wherein registration module detects printed features on the administrable increment of the drug to determine the drug name.

8. The apparatus according to claim 5, wherein the administrable increment is one of a pill, a capsule, a lozenge, and an ampoule.

9. The apparatus according to claim 1, wherein the contextual information includes a name of a patient to which the drug corresponding to the drug name is being administered.

10. The apparatus according to claim 9, wherein the patient is undergoing a surgical procedure.

11. The apparatus according to claim 9, wherein the contextual information includes a name of a medical procedure performed on the patient.

12. A method of tracking usage of drugs in a medical procedure, comprising:
acquiring an image corresponding to a drug administered to a patient during a medical procedure;
identifying a name of the drug administered to the patient by using the acquired image;
registering the name of the drug administered to the patient in an expended drug table; and
displaying the registered name and on a display screen along with information related to the patient and the medical procedure.

13. The method of claim 12, further comprising:
displaying the information related the patient and the medical procedure in a color that is different from the registered name.

14. The method of claim 12, wherein the image corresponding to the drug administered to the patient includes a bar code.

15. The method of claim 12, wherein the acquiring of the image corresponding to the drug administered to the patient during the medical procedure occurs after the medical procedure has been completed.

16. The method of claim 12, wherein identifying the name of the drug involves detecting a color of an administrable increment of the drug.

17. The method of claim 12, wherein the image corresponding to the drug administered to the patient is an image of a label of a drug container, and identifying the name of the drug involves recognition of the label in the image of the drug container.

18. A non-transitory, computer-readable medium storing a program which when executed in a computing device causes the computing device to perform steps of a method comprising:
acquiring an image corresponding to a drug administered to a patient during a medical procedure;
identifying a name of the drug administered to the patient by using the acquired image;
registering the name of the drug administered to the patient in an expended drug table; and
displaying the registered name and on a display screen along with information related to the patient and the medical procedure.

19. The non-transitory, computer-readable medium of claim 18, the steps further comprising:
displaying the information related the patient and the medical procedure in a color that is different from the registered name.

20. The non-transitory, computer-readable medium of claim 18, wherein the identifying the name of the drug administered to the patient involves comparison of surface features of an administrable increment of the drug in the acquired image to drug surface features stored in a database unit.
